(19) United States
(12) Patent Application Publication
(10) Pub. No.: US 2013/0235843 A1
(43) Pub. Date: Sep. 12, 2013

(54) ALLEVIATION OF TCP PERFORMANCE DEGRADATION DUE TO CARRIER SUSPENSION OR UE TUNE-AWAY

(71) Applicant: QUALCOMM INCORPORATED, San Diego, CA (US)

(72) Inventors: Amir Aminzadeh Gohari, San Diego, CA (US); Navid Ehsan, San Diego, CA (US); Thomas Klingenbrunn, San Diego, CA (US); Shyamal Ramachandram, San Diego, CA (US); Arvind Swaminathan, San Diego, CA (US); Srinivasan Balasubramanian, San Diego, CA (US)

(73) Assignee: Qualcomm Incorporated, San Diego, CA (US)

(21) Appl. No.: 13/688,157

(22) Filed: Nov. 28, 2012

Related U.S. Application Data
(60) Provisional application No. 61/608,589, filed on Mar. 8, 2012.

(51) Int. Cl. H04W 80/06

(52) U.S. Cl. CPC H04W 80/06
USPC 370/331

(57) ABSTRACT

A method, an apparatus, and a computer program product for wireless communication are provided in which a probability of occurrence of an event expected to occur within a period of time is determined, where the event comprises one or more of a tune-away event and a suspension event. One or more transmission control protocol parameters are manipulated before the occurrence of the event when the probability of occurrence exceeds a threshold to increase a retransmission time out parameter value, or to maintain a desirable congestion window size. The transmission control protocol parameters may be manipulated by delaying, duplicating or dropping acknowledgements and/or by selectively dropping received packets before, during, or after the event.

### CROSS-REFERENCE TO RELATED APPLICATION(S)

Pursuant to 35 U.S.C. §119(e), this application claims the benefit of U.S. Provisional Application Ser. No. 61/608,589 filed on Mar. 8, 2012, the contents of which are hereby incorporated by reference herein in their entirety.

### BACKGROUND

1. Field

The present disclosure relates generally to communication systems, and more particularly, to wireless data communications systems.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method of wireless communication comprises determining a probability of occurrence of an event expected to occur within a period of time, the event comprising one or more of a tune-away event and a suspension event.

In an aspect of the disclosure, the method of wireless communication comprises manipulating one or more transmission control protocol (TCP) parameters before the occurrence of the event when the probability of occurrence exceeds a threshold. Manipulating the one or more TCP parameters may include causing a TCP server to increase a retransmission time out parameter value. Causing the TCP server to increase the retransmission time out parameter value may include changing a modem behavior related to transmission of acknowledgements from the modem. Changing the modem behavior may comprise delaying transmission of one or more of the acknowledgements. Changing the modem behavior may comprise varying a response time measured between receipt of packets at the modem and transmission of corresponding acknowledgements by the modem to obtain a desired variability of response times. Changing the modem behavior may comprise refraining from transmitting one or more acknowledgements from the modem. Causing the TCP server to increase the retransmission time out parameter value may include changing a modem behavior related to transmission of one or more packets by the modem. Changing the modem behavior may comprise recording a sequence of acknowledgments received by the modem and providing at least one of the recorded acknowledgements to the TCP server during the event.

In an aspect of the disclosure, manipulating one or more TCP parameters before the occurrence of the event includes causing a TCP server to modify the one or more TCP parameters, and may further comprise manipulating at least one of the TCP parameters after the occurrence of the event. Manipulating the at least one TCP parameter after the occurrence of the event may include causing a TCP server to restore the values of the one or more TCP parameters to pre-event values. The one or more TCP parameters may comprise one or more of a retransmission time out parameter, a transmit window parameter, and a parameter controlling delay of transmission of a packet acknowledge. Causing a server to restore the values may include causing the server to decrease the retransmission time out parameter value by half.

In an aspect of the disclosure, manipulating the one or more TCP parameters includes causing a TCP server to modify a transmit congestion window value. The transmit congestion window may be decreased prior to the event. Manipulating the one or more TCP parameters may include causing the TCP server to increase a retransmission time out parameter value by changing a modem behavior related to transmission of acknowledgements from the modem. Changing the modem behavior may comprise transmitting at least one duplicate acknowledgement in response to a packet received by the modem. The duplicate acknowledgement may be a copy of an acknowledgement sent in response to a previous packet received by the modem.

In an aspect of the disclosure, determining the probability of occurrence of the event includes determining a frequency of occurrence of a sequence of prior tune-away events. The frequency of occurrence of the prior tune-away events may be determined based on a frequency of occurrence of TCP time outs. Determining the probability of occurrence of the event may include determining an expected duration of the event. The one or more TCP parameters may be manipulated based on the expected duration.

In an aspect of the disclosure, the method of wireless communication comprises reducing the frequency of occurrence of a plurality of tune-away events based on the determined frequency of occurrence of the prior tune-away events.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating TCP transmission in a wireless network.

FIG. 8 is a diagram illustrating aspects related to tune-away gaps in a wireless network.

FIG. 9 is a flow chart of a method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

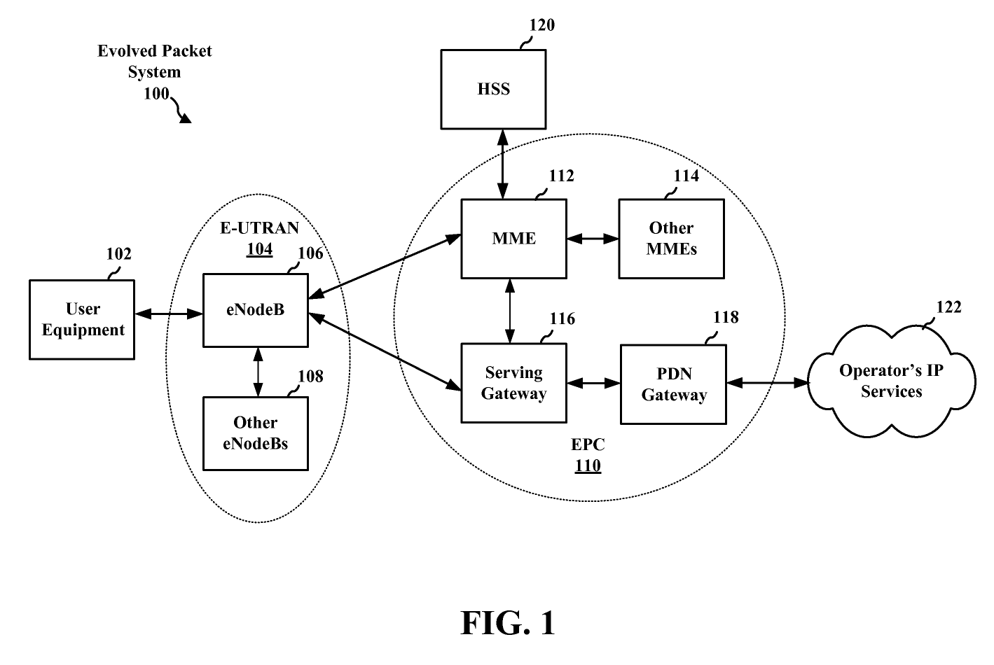

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

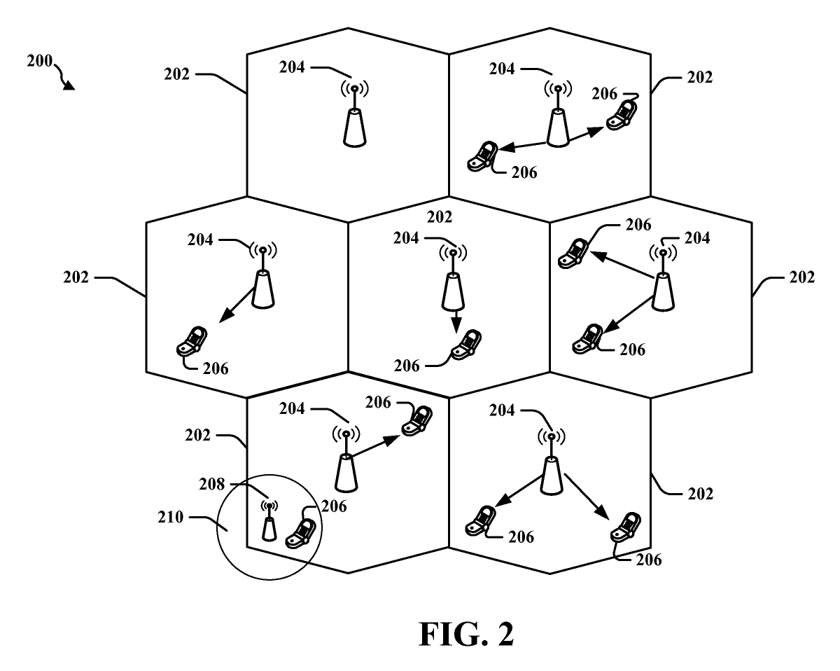

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

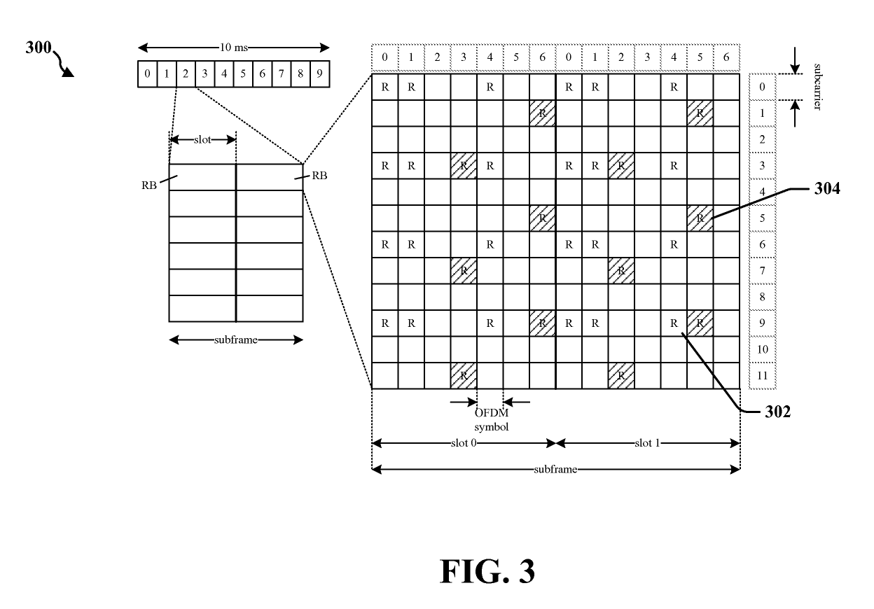

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

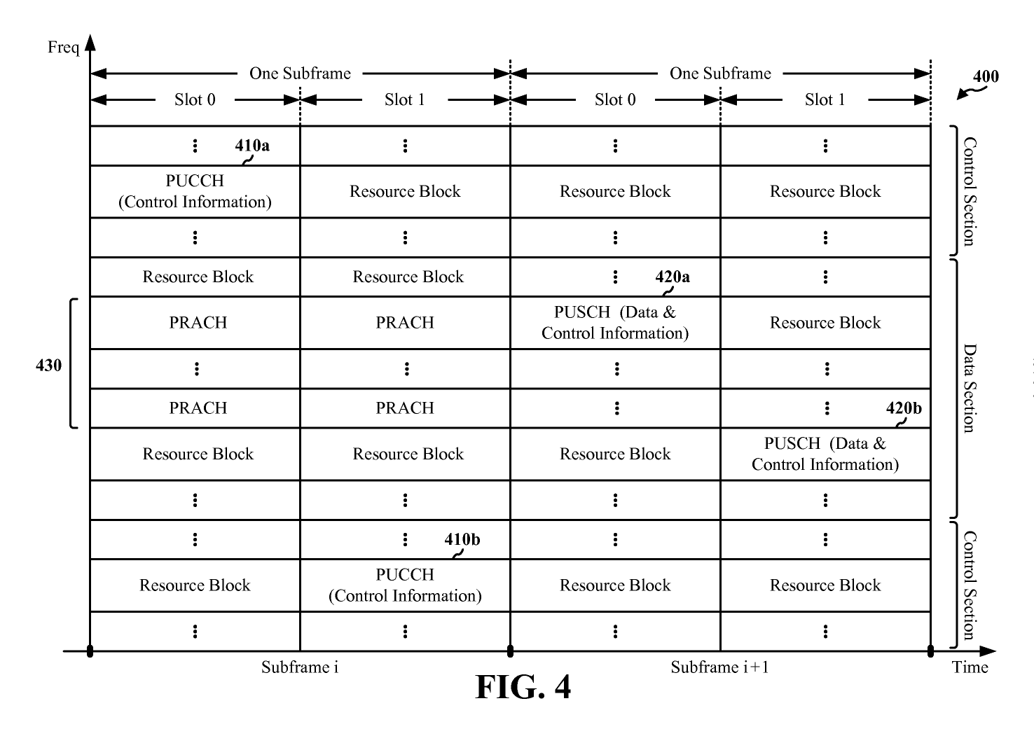

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

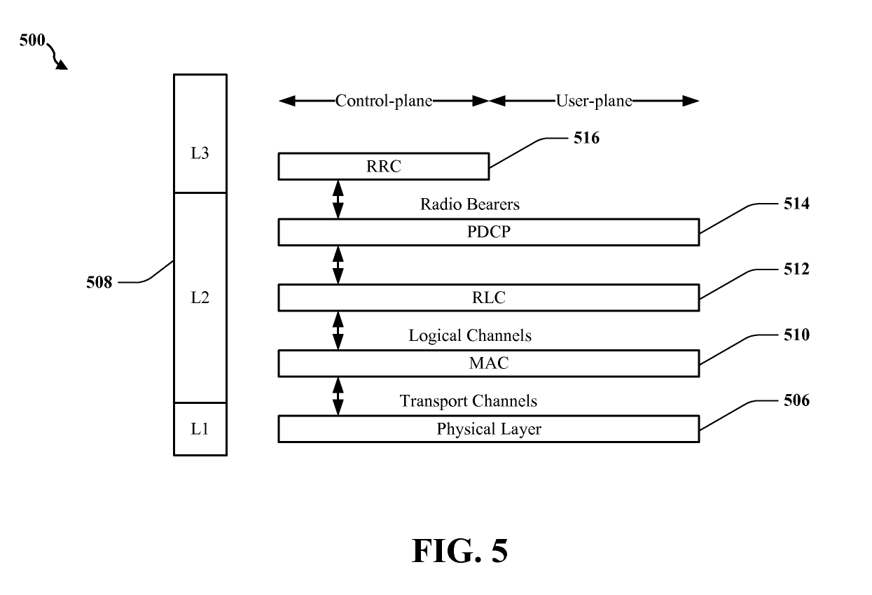

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

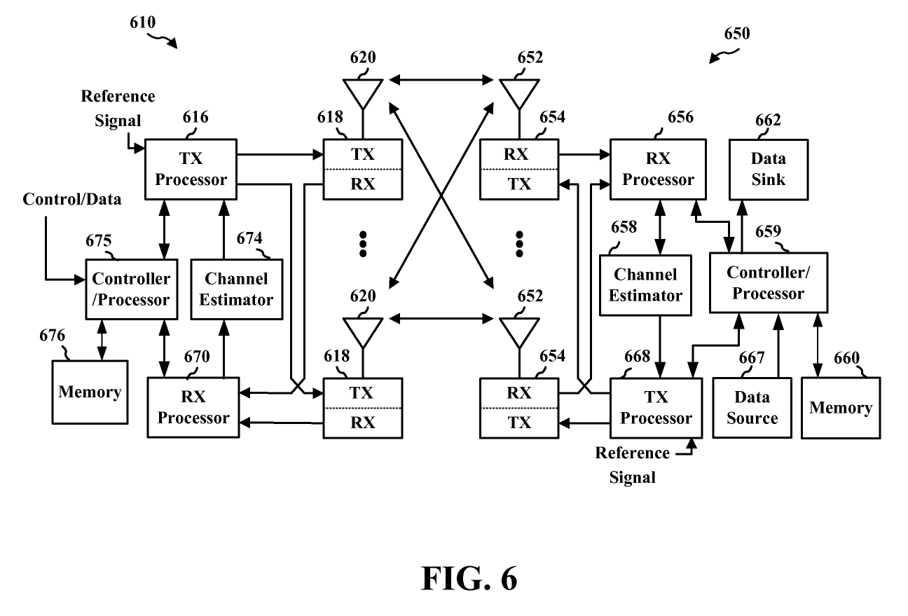

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

High Speed Packet Access and evolved High Speed Packet Access (interchangeably referred to herein as HSPA) may be used for high speed data communications in wireless networks including WCDMA, 3GPPP and LTE networks. PDCP may be used to transfer data over a wireless link, using RLC.

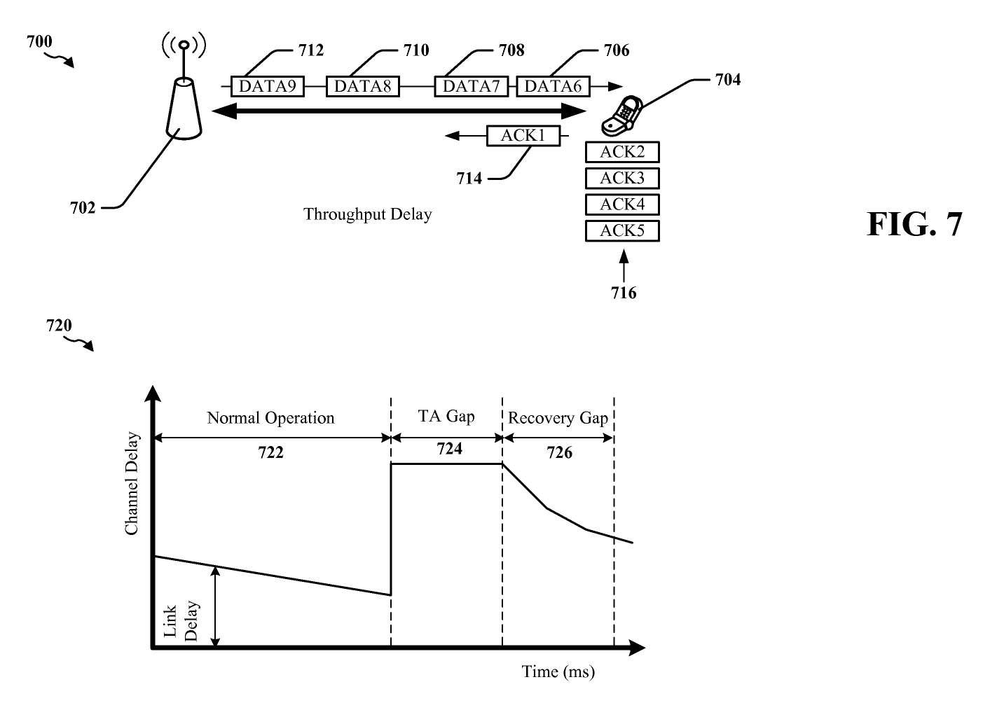

FIG. 7 illustrates packet flow in a wireless network. To simplify description of certain aspects of the invention, FIG. 7 depicts a transfer of packets from eNB 702 to UE 704, although it will be appreciated that packet flow is typically bidirectional and that certain principles described herein can be applied to uplink packet transfers from UE 704 to eNB 702. Transmission Control Protocol (TCP) may be used to provide reliable, ordered delivery of packets 706, 708, 710 and 712 to be transmitted by eNB 702 to UE 704. When UE 704 receives a packet 706, 708, 710 or 712, it verifies that the packet is received without error by sending an acknowledgement (ACK) 714 that identifies the received packet. The UE 704 may receive additional packets 706, 708, 710, 712 before acknowledging an earlier received packet. Thus, UE 704 may transmit an ACK 714 for a first a packet received while receiving a sixth packet 706.

For each transmitter 702 or 704, TCP provides a flow control mechanism that defines a transmit congestion window size that establishes a packet rate at which transmitter 702 or 704 may transfer packets to ensure reliable delivery and to limit congestion. TCP flow control and other functions may be performed by a TCP server created and/or assigned to manage one or more connections. The congestion window size may limit the number of packets 706, 708, 710 and 712 and/or the size of data that eNB 702 or UE 704 can send without receiving an ACK 714. The congestion window size may be adjusted as channel conditions change or as the receiver becomes congested, resulting in one or more dropped packets. Packets may be dropped when they arrive corrupted at the receiver or when the receiver cannot store an incoming packet due to a lack of available buffers. Dropped packets must be retransmitted and can cause degradation of transmission throughput. Therefore, the congestion window size is typically selected to enable a transmitter to send as many packets as can be reliably received by the receiver without retransmission necessitated by congestion.

In the example depicted in FIG. 7, eNB 702 transmits 9 packets before the first ACK 714 is received. Receiver UE 704 may have processed additional packets 2-5 and may have queued ACKs 716 corresponding to those additional packets. If a packet is lost through corruption, the receiver UE 704 may not respond with an ACK. The transmitter maintains a timer for each TCP connection that determines the time elapsed since transmission of a packet. After a predefined time has elapsed (timeout period), the transmitter eNB 702 may determine that the packet has been corrupted or dropped and may begin a retransmission of the packet. The transmitter eNB 702 may optionally reduce the transmit congestion window size. The transmitter eNB 702 keeps a record of each unacknowledged packet sent to enable resending should the packet be lost in transmission or dropped by the receiver UE 704. Therefore, a smaller congestion window can reduce required buffer size at the transmitter eNB 702. The timer is needed in case a packet gets lost or corrupted.

In certain wireless networks, UE 704 may be simultaneously registered or have access to two or more network entities that operate using different radio access technologies (RATs) through a single radio. UE 704 may be required to quickly tune-away (TA) from one network in connected mode for a short period of time in order to perform certain tasks on the second network, such as monitoring pages, etc. After switching from a first network to perform a TA function, the UE 704 may not be able to receive packets on the first network. These packets are typically held at the eNB 702 during the resultant TA gap until the UE 704 has resumed the connection in the first network. Periodic TA gaps may cause frequent and periodic TCP timeouts and may degrade channel throughput and may congest eNB 702 during TA gaps. The switching of UE 704 from the first network may be referred to as a TA event.

Assuming that radio link failure (RLF) is not declared and the RLC connection is not terminated because of the TA gaps, TCP timeouts may occur without causing termination of a TCP connection, but TCP timeouts typically impact system performance. In particular, TCP timeouts may cause additional retransmissions and can cause increases in related overhead because of timeouts, although packets are not lost because of TA gap. TCP is transmitted using RLC acknowledge mode (AM), and every TCP timeout may result in a retransmission, which can substantially impact network resources. Moreover, a TCP server in the eNB 702 may assume that timeouts are caused by network congestion and may decrease packet rate accordingly. Frequent timeouts can cause dramatic under-utilization of TCP sessions for a UE 704 that performs TA activities.

Tune-away may impact channel throughput. Each occurrence of a TA event may cause UE 704 to miss downlink schedules and/or uplink grants that determine the availability of bandwidth for communication between eNB 702 and UE 704. The UE 704 may fail to provide HARQ replies acknowledging transmissions from the eNB 702, which may be interpreted as a negative acknowledge (NACK) by the eNB 704. The failure to provide HARQ replies may cause a reduction in Channel Quality Indicator (CQI) that may cause a scheduler to reduce channel throughput after a TA gap has occurred. In LTE networks, for example, PDCP/RLC throughput may be affected. CQI is a measurement of communication quality of wireless channels. CQI can be expressed as one or more values representing a measure of channel quality for a particular channel. Typically, a high value CQI is indicative of a channel with high quality.

With reference to the timing chart 720, there is typically no channel throughput during a TA gap 724, and it may take considerable time to recover an optimal channel throughput. The duration of a recovery interval 726 may be 1.5 times greater than the duration of the TA gap 724, where the recovery interval 726 represents the time elapsed before the UE 702 is scheduled at a rate expected of the UE 702 if it were operated without TA gaps 724. It can be expected that differences in CQI resulting from the effect of the TA gap 724 may significantly impact throughput during the recovery interval 726, but typically does not affect the duration of the recovery interval 726.

In general, TCP estimates the network's round trip time (RTT) using an exponential moving average with a weight of α=0.8-0.9. This means that if the number of samples (˜packet rate) is large enough outside the TA gap (which is true at high data rates), then the RTT estimate of TCP would not have a memory of any previous TA gap at the beginning of the current TA gap. When retransmission time out (RTO) value is calculated as a function of the RTT estimate, the deviation of RTT samples would not have a memory of the RTT samples of the previous gaps. Therefore, there is a high chance that the TCP packet being sent at the beginning of a TA gap 724 will timeout and cause a sudden drop in the TCP congestion window size.

Furthermore, each packet timeout may affect a slow-start algorithm that may be used by a TCP server to manage congestion, whereby the TCP congestion window size may be increased each time an ACK acknowledgment is received until either an ACK is not received or a until predetermined threshold value is reached. When a packet loss occurs, the TCP server may assume network congestion and may reduce the TCP congestion window size. When a loss occurs, a Slow Start Threshold (SSThresh) may be set to half the current TCP congestion window size and a slow start initiated with a low value for initial TCP congestion window size. When current congestion window size reaches the SSThresh value, the TCP server may initiate a congestion avoidance mode whereby each ACK increases the TCP current congestion window size. Each timeout due to TA gap 724 may result in dividing the SSThresh parameter in half and after a few timeouts the slow start algorithm is practically not in use. This in turn will dramatically impact the actual throughput of the TCP session, causing it to be much lower than its nominal throughput.

RTO may be controlled by the TCP server based on a history of delay values between transmission of packets and receipt of their corresponding ACKs. The occurrence of a TA event may result in long delays during at least a portion of the TA gap 724, which can cause frequent TCP timeouts because the TCP server does not remember or consider long delays caused by previous TA gaps 724. Consequently, the TCP server's RTO parameter may have converged on a relatively short time value for normal link operation at the time the TA event occurs. As a result, the delays caused by the TA gap 724 are more likely to cause TCP timeouts.

During a TA gap 724, the eNB 702, or other base station, may be required to buffer incoming downlink data for UE 704. For example, if UE 704 was downloading data at 50 Mbps right before a TA gap 724 of duration 160 ms, with a current congestion window value set to delay/bandwidth product, then eNB 702 may be required to buffer 1 Mbyte of data for the UE 704. The amount buffer storage required can be greater if the TCP current congestion window size exceeds the delay/bandwidth product. Accordingly, TA gap 724 may cause buffer overflow at the eNB 702. Uplink bit rate tends to be significantly less than downlink rates. Nevertheless, UE 704 may be required to buffer large amounts of uplink data during TA gap 724.

In certain embodiments of the invention, TCP timeouts can be avoided during TA gap 724 by causing a TCP server on the UE 704 or eNB 702 to increase its RTO parameter value before the beginning of TA gap 724. The TA server may be induced to increase RTO value when a modem delays one or more ACKs prior to the occurrence of the TA gap 724, increases jitter related to a plurality of ACKs before the occurrence of TA gap 724, and/or intentionally drops one or more ACKs before the occurrence of TA gap 724.

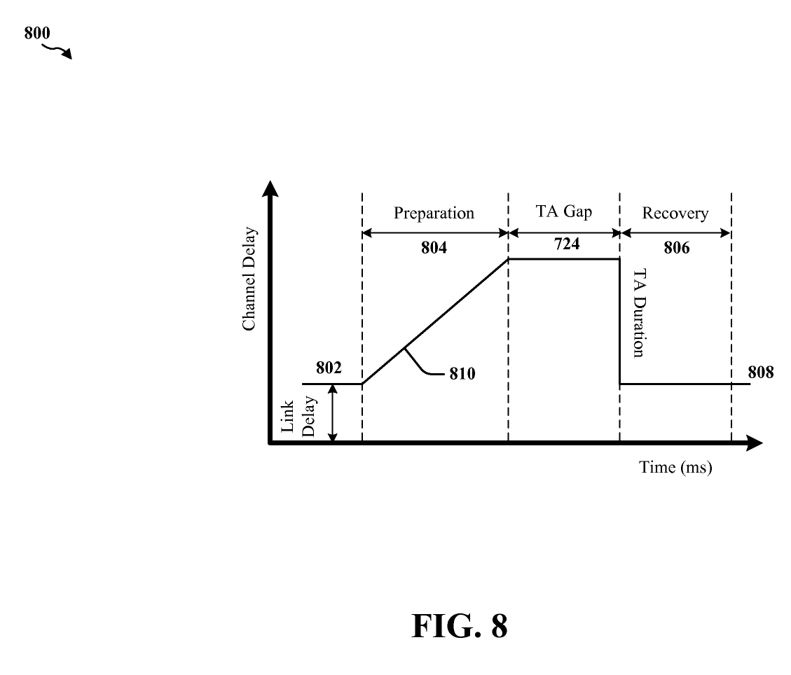

FIG. 8 includes a timing diagram 800 that illustrates certain aspects of RTO manipulation. In one example, the RTO value may be increased when UE 704 deliberately delays ACKs for an interval of time (preparation interval 804) before the occurrence of the TA gap 724. The TCP server may compute RTO using an estimate of RTT that is calculated using timing of packets and ACK sent in response to those packets. The calculation of RTO may involve an exponential moving average and the occurrence of ACK delays immediately before the TA gap 724 may result in fewer timeouts due to the enlarged RTO value. The increased RTO is typically achieved using a plurality of increasingly delayed ACKs to avoid a timeout that may be caused if the first increased delay exceeds the initial RTO value. An increased RTO may be accomplished using a series of increasing delays, which may be determined by a delay manipulation function, and which successively move the RTO value until the TCP server can tolerate ACK delays of a duration expected during the TA gap 724. The duration of and the shape of the delay manipulation function may be selected to optimize channel throughput.

In some embodiments, the delay manipulation function is linear over a predetermined or configured interval of time (i.e., the preparation interval 804) before the TA gap 724. Preparation interval 804 may have a duration that is sufficiently long that the increase in the TCP RTO parameter eliminates or reduces timeouts caused by TA gap 724. On the other hand, a longer preparation interval 804 may result in a greater average end-to-end delay. Therefore, a trade-off may be needed between avoiding potential timeouts and introducing extra delays into the system to avoid the potential timeouts. In one example, the trade-off results in a preparation interval 804 selected to be twice the duration of the TA gap 724, with a linear delay increase function 810 used during the interval. In another example, UE 704 may delay all ACKs, except ACKS sent during a recovery period 806, to manipulate the RTT estimate maintained by a TCP server and to ensure that resulting RTO is sufficiently long to cover the delays caused by the TA gap 724. The constant delay added to the ACK packets may be selected to obtain a maximum RTO value immediately before the TA gap 724 occurs, thus minimizing or eliminating timeouts associated with the TA gap 724.

The RTO may be manipulated by increasing the variability of ACK response timing. RTO may be set based on an average RTT estimate and a standard deviation of RTT estimates. Therefore, RTO may be manipulated by varying ACK response times such that the RTO is maintained at a desired level. In one example, RTO is manipulated to a desired level and thereafter delays are introduced into some ACK response times. The delays may be introduced periodically based on a time interval, and/or may be introduced for a percentage of ACKs. For example, the delay may be introduced for every second or third ACK. The introduction of variable delays may appear as jitter in RTT and this jitter may be selected to increase RTO during the preparation interval 804.

In certain embodiments, RTT and RTO may be manipulated by selectively dropping TCP ACK packets. TCP ACKs are cumulative, in that an ACK can be taken to confirm error-free reception of all packets up to and including the packet that is explicitly acknowledged. After a dropped ACK for a first packet, a subsequent ACK for a second packet may be counted as a delayed ACK for the first packet. An RTT estimating module may count the subsequent ACK as two ACKs with different delay times (one for each acknowledged packet). Accordingly, one or more dropped ACKs can serve to introduce delays into the ACK mechanism and therefore increase RTT and cause the RTO to be correspondingly increased.

Buffer overflows at eNB 702 may be avoided by causing the TCP congestion window of the eNB 702 TCP server to be small enough before UE 704 tunes away. In some embodiments, UE 704 may deliberately drop one or more TCP data packets during preparation interval 804. Dropping packets in this manner, the UE 704 can ensure that congestion avoidance, or fast recovery mode of operation is initiated and in effect for at least a portion of the TA gap 724. In some embodiments, the duration of the TA gap 724 and timing of the dropped packets may result in congestion avoidance mode being in effect for a majority of the TA gap 724.

In some embodiments, duplicate TCP ACKs may be transmitted on the uplink during the preparation interval 804. A TCP server may interpret 2 or 3 duplicate ACKs as dropped packets by the TCP server. The number of duplicate ACKs that will be treated as dropped packets can vary between TCP implementations.

When the UE 704 is a TCP sender, which occurs on the uplink, reductions in throughput related to the TA gap 724 may be alleviated by generating duplicate ACKs locally at the UE 704. The lower layers of the UE 704 stack, corresponding to the modem, may maintain a local cache of the last transmitted TCP ACKs for each connection. During the TA gap 724, when UE 704 is not receiving new data, the cached copy of TCP ACKs may be played out to the TCP stack on the UE 704. These apparent duplicate ACKs may be construed as indicating that the TCP receiver is receiving at least some TCP segments. As a result, the congestion control algorithm of the UE 704 TCP sender may be slowed, thereby preventing a total collapse of the current congestion window. Accordingly, recovery may be facilitated and a faster restoration of throughput may be obtained after the TA gap 724 has ended and the normal TCP session 802, 808 has resumed.

For uplink data transmission, the TCP server may be near, or at the UE 704. TCP throughput performance degradation attributable to the TA gap 724 may be addressed or alleviated by adapting or configuring a portion of the TCP stack at the TCP server. In some embodiments, the minimum RTO value may be modified. The server typically chooses between minimum RTO value and an estimated RTO value, choosing whichever RTO value is greater. The minimum RTO value may be 200 ms for Linux systems, for example, and can be adjusted to exceed the expected RTT plus TA gap 724 duration. In some embodiments, TCP transmit congestion window size may be adaptively changed to avoid buffer overflows at the UE 704 during TA gap 724.

In some embodiments, timeouts may be avoided and throughput degradation reduced, even where knowledge of the characteristics of TA gaps 724 is limited. For example, timeout patterns can be detected at a TCP client when the knowledge of TA gaps 724 duration and periodicity is not known to the TCP client. The patterns may be based on past timeouts at the TCP server. The TCP sender may maintain a history of the times at which timeouts have occurred over a preceding period of time. In one example, the period of time may be 300 seconds. The distribution of timeouts during the period of time may be examined to determine if there a periodic pattern exists. If a periodic pattern is detected, the TCP sender can avoid the timeouts by using a RTO=N_{scale}×RTOₙₒₘᵢₙₐₗ for the TCP segments transmitted within T_{buffer} ms before or after the estimated periodic instances. In one example, T_{buffer}=100 ms, N_{scale}=2 and RTOₙₒₘᵢₙₐₗ is the RTO calculated by a native TCP implementation. In some embodiments, periodic patterns are detected using autocorrelation or frequency domain analysis of the stored timeout pattern.

In some embodiments, throughput degradation can be reduced when a periodic pattern cannot be easily detected. Throughput degradation may be reduced by suppressing or limiting the transmission of stale timeouts. Throughput may be adversely affected because the transmit congestion window frequently drops to a value of 1 during the recovery period 806 and normal operation period 808 between consecutive TA gaps X and X+1. The decreased congestion window may occur because multiple retransmit timers can expire at the TCP sender during the recovery period. In many instances, additional timeouts may occur after the retransmissions triggered by the first timeout are successfully acknowledged and after the transmit congestion window is increasing. These additional timeouts may cause SSThresh to be halved for each timeout. As a result, the slow-start phase shrinks and the recovery of transmit congestion window is slowed.

Stale timeouts can be prevented from affecting recovery by modifying the retransmission timers that are running when the first timeout occurs. In particular, when the first timeout occurs, the RTO estimate at the sender is typically doubled under normal TCP behavior. Hence, stale timeouts may be prevented and recovery accelerated by extending the unexpired retransmit timers of other segments. In some embodiments, the extension is half the new RTO estimate.

When stale timeouts are avoided, it can be expected that the transmit congestion window value will increase more quickly in the recovery period following TA events, because ACKs that are received in response to the first retransmission will acknowledge many TCP segments, assuming RLC has prevented or limited loss of TCP segments. The transmit congestion window value may become large quickly because the TCP sender is in slow start phase. Even if RLC does not prevent loss of TCP segments, the segments are more likely to be retransmitted due to duplicate ACKs rather than timeouts, which have been extended.

UE 704 typically cannot directly access the TCP server and its congestion avoidance scheme or otherwise directly influence the operation of a TCP server that transmits downlink data. In certain embodiments, however, a TCP client or other module may be modified at UE 704 to regulate ACK transmissions. In one example, ACK packets may be delayed before the TA gap 724 to obtain a favorable RTO parameter at the TCP server. In some embodiments, a calculated number of duplicate ACKs may be transmitted before the TA gap 724 to ensure that the TCP server's congestion window is set to a smaller value for the duration of TA gap 724. The number of duplicate ACKs and the duration of a preparation interval 804 in which the duplicate ACKs are transmitted may be dynamically configured or otherwise modified and may be used as optimization variable to obtain desired transmission performance.

When TA gaps 724 occur frequently, UE 704 may not recover completely from a loss of TCP throughput, because additional TA gaps 724 may follow in close enough succession that recovery is not fully accomplished. The TCP throughput on the UE 724 can be improved by reducing the rate of occurrence of TA gaps 724. Decreasing the rate of occurrence of TA gaps 724 may require adjustment or tuning of the UE 704 behavior in other RATs to ensure adequate paging performance on a 1× RTT radio, for example. Accordingly, TA gap 724 periodicity may be reduced only when the impact to throughput is sufficient to justify loss of performance in other RATs.

In certain embodiments, TA gap 724 periodicity may be regulated based on local TCP timeouts. The UE 704 may count the number of TCP timeouts experienced locally and a moving average of the count may be maintained. When the moving average of the count exceeds a preset threshold, or a longer-term moving average of the count, the UE 704 may provide a trigger to reduce the frequency of page monitoring on the 1× RTT system to increase the gap between successive TA events. For example, every other page monitoring event may be suppressed, when measurable degradation to TCP performance is observed.

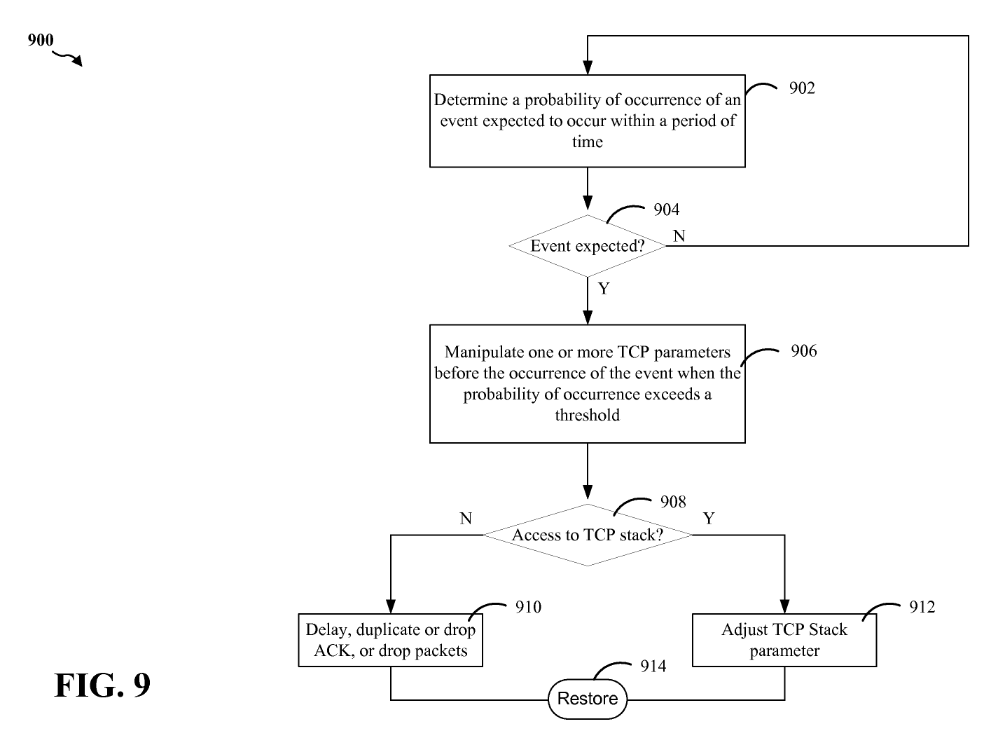

FIG. 9 is a flow chart 900 of a method of wireless communication. The method may be performed by a UE 704. At step 902, the UE 704 determines a probability of occurrence of an event which is expected to occur within a period of time. The event may be one or more of a tune-away event and a suspension event. The event may cause a TA gap 724 during which UE 704 ceases transmissions to an eNB 702.

In certain embodiments, determining the probability of occurrence of the event includes determining a frequency of occurrence of a sequence of prior tune-away events. The frequency of occurrence of the prior tune-away events may be determined based on a frequency of occurrence of TCP time outs. Determining the probability of occurrence of the event may include determining an expected duration of the event, and one or more TCP parameters may be manipulated based on the expected duration of the TA gap 724.

In some embodiments, the UE 704 may reduce the frequency of occurrence of a plurality of tune-away events based on the determined frequency of occurrence of the prior tune-away events. Such reduction typically involves a tradeoff of TCP performance against operational requirements of the UE 704 with regard to one or more other RATs.

If at step 904, it is determined whether the probability of occurrence of the event does not exceed a threshold probability, then normal operation 722 is continued (returning to step 902).

If at step 904, it is determined that the probability of occurrence of the event exceed a threshold probability, then at step 906, the UE 704 manipulates and/or initiates manipulation of one or more TCP parameters before the occurrence of the event. As illustrated in FIG. 8 the manipulation may commence in a preparation interval 804 that precedes the expected event. Duration of the preparation interval 804 may be selected according to the characteristics of the operation of UE 704, eNB 702 and other components of a wireless system. Manipulation of the TCP parameters may continue into the TA gap 724 and extend into a recovery period 806.

At step 908, the type of manipulation of TCP parameters may be determined based on whether a TCP server, client or other part of the TCP stack may be configured or adapted by the UE 704.

If TCP behavior cannot be directly altered by the UE 704, then at step 910, the behavior of the stack may be changed by manipulating or influencing a TCP server or client to adjust one or more TCP parameters by delaying, duplicating or delaying ACKs, or by selectively dropping packets. In some embodiments, manipulating one or more TCP parameters includes causing a TCP server to increase a retransmission time out parameter value. The TCP server may be caused to increase the retransmission time out parameter value by changing a modem behavior related to transmission of acknowledgements from the modem. Changing the modem behavior may comprise delaying transmission of one or more ACKs. Changing the modem behavior may comprise varying a response time measured between receipt of packets at the modem and transmission of corresponding ACKs by the modem to obtain a desired variability of response times. Changing the modem behavior may comprise refraining from transmitting one or more ACKs from the modem.

In some embodiments, the TCP server may be caused to increase the RTO parameter value by changing a modem behavior related to transmission of one or more packets by the modem. Changing the modem behavior may comprise recording a sequence of acknowledgments received by the modem and providing at least one of the recorded acknowledgements to the TCP server during the event.

In some embodiments, manipulating the one or more TCP parameters includes causing a TCP server to modify a transmit congestion window value. The transmit congestion window may be decreased prior to the event. Manipulating the one or more TCP parameters may include causing the TCP server to increase an RTO parameter value by changing a modem behavior related to transmission of acknowledgements from the modem. Changing the modem behavior comprises transmitting at least one duplicate acknowledgement in response to a packet received by the modem. The duplicate acknowledgement may be a copy of an acknowledgement sent in response to a previous packet received by the modem.

During or after the occurrence of TA gap 724, the UE 704 may begin recovery at step 914 to restore optimal TCP parameter settings for normal operation.

If at step 908 it is determined that a TCP stack is accessible to adaptation by the UE 704, then at step 912, the behavior of the stack may be manipulated by delaying, duplicating or dropping ACKs, or by selectively dropping packets. Manipulating the one or more TCP parameters before the occurrence of the event includes causing a TCP server to modify the one or more TCP parameters. The manipulation may include further manipulating at least one of the TCP parameters after the occurrence of the event during recovery period 806. The one or more TCP parameters comprise one or more of a retransmission time out parameter, a transmit window parameter, and a parameter controlling delay of transmission of a packet acknowledge. Manipulating a TCP parameter after the occurrence of the event may include causing a TCP server to restore the values of the one or more TCP parameters to pre-event values at step 914. The one or more restored TCP parameters may comprise a retransmission time out parameter, and the server may restore the values of the includes causing the server to decrease the retransmission time out parameter value by half.

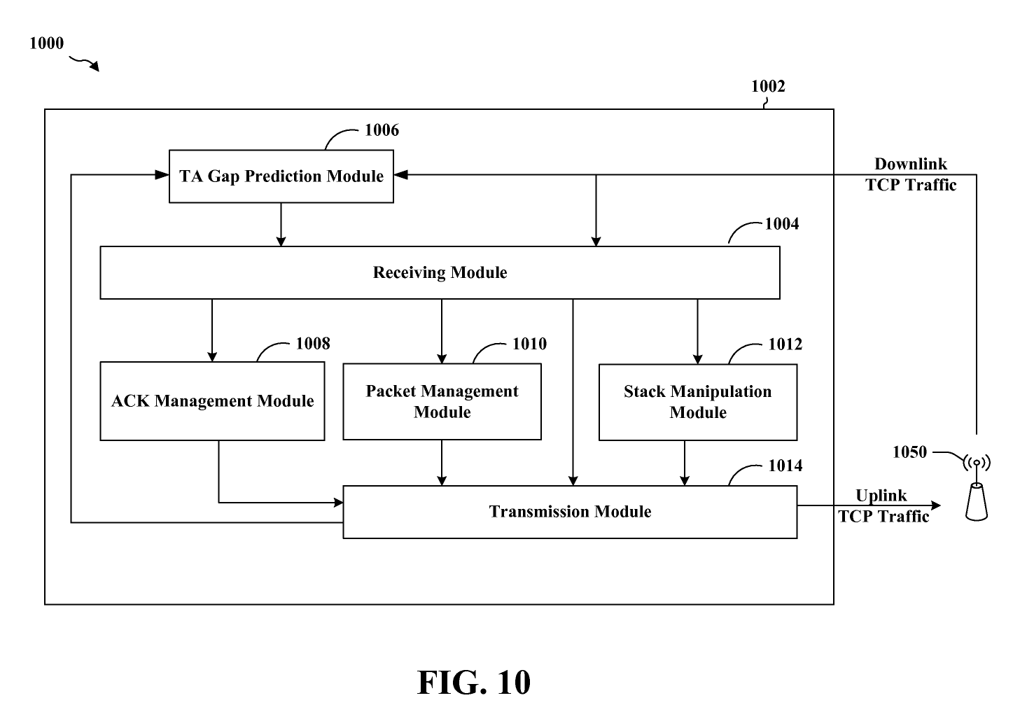

FIG. 10 is a conceptual data flow diagram 1000 illustrating the data flow between different modules/means/components in an exemplary apparatus 1002. The apparatus may be a UE 704. The apparatus 1002 includes a module 1004 that receives TCP packets, a module 1006 determines the probability of a TA event occurring, a module 1008 that manages, controls and manipulates the timing of TCP ACK transmissions by the UE 704, a module 1010 that selectively drops or buffers TCP received packets, a module 1012 that can reconfigure or adapt a TCP stack of the UE 704 and a transmission module 1014 that responds to modules 1004, 1008, 1010, and 1012 and transmits TCP traffic to an eNB 1050. The apparatus may include additional modules that perform each of the steps of the algorithm in the aforementioned flow charts FIG. 9. As such, each step in the aforementioned flow charts FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

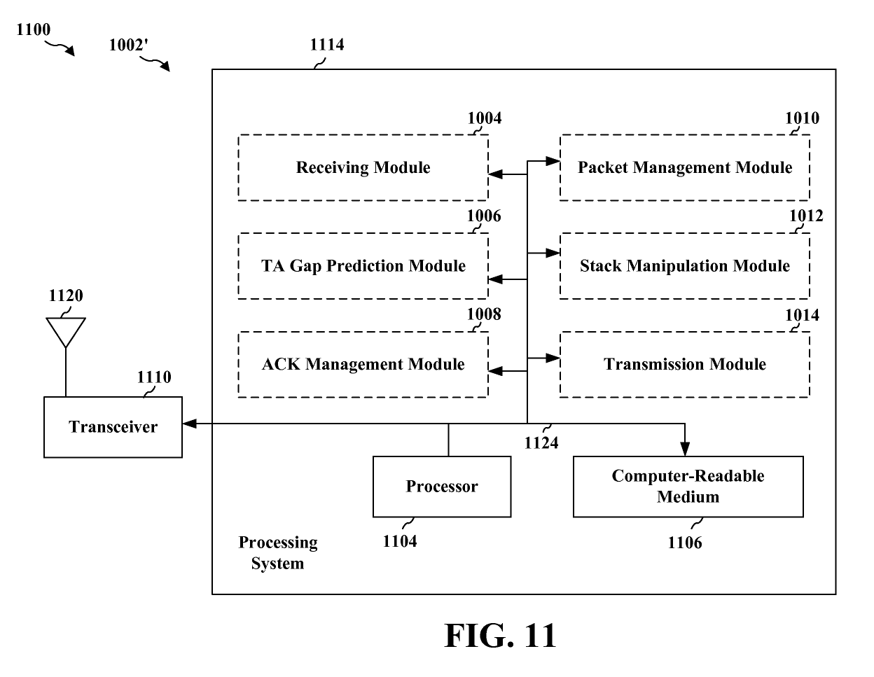

FIG. 11 is a diagram illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, 1012, and 1014 and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the 1004, 1006, 1008, 1010, 1012, and 1014. The modules may be software modules running in the processor 1104, resident/stored in the computer readable medium 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659. In one example, transmitting module 1014 and receiving module 1004 may be implemented using TX processor 668 and RX processor 656, respectively.

In one configuration, the apparatus 1002/1002′ for wireless communication includes means 1006 for determining a probability of occurrence of an event which is expected to occur within a period of time. The event may be one or more of a tune-away event and a suspension event. The event may cause a TA gap 724 during which UE 704 ceases transmissions to an eNB 702.

In certain embodiments, means 1006 determines a frequency of occurrence of a sequence of prior tune-away events. The frequency of occurrence of the prior tune-away events may be determined based on a frequency of occurrence of TCP time outs. In certain embodiments, means 1006 determines an expected duration of the event, and one or more TCP parameters may be manipulated based on the expected duration of the TA gap 724.

In some embodiments, the UE 704 may reduce the frequency of occurrence of a plurality of tune-away events based on the determined frequency of occurrence of the prior tune-away events. Such reduction typically involves a tradeoff of TCP performance against operational requirements of the UE 704 with regard to one or more other RATs.

In one configuration, the apparatus 1002/1002′ for wireless communication includes means 1008, 1010 and 1012 for manipulating one or more TCP parameters before the occurrence of the event. As illustrated in FIG. 8 the manipulation may commence in a preparation interval 804 that precedes the expected event. Duration of the preparation interval 804 may be selected according to the characteristics of the operation of UE 704, eNB 702 and other components of a wireless system. Manipulation of the TCP parameters may continue into the TA gap 724 and extend into a recovery period 806.

In one configuration, the apparatus 1002/1002′ for wireless communication includes means 1008 for manipulating or influencing a TCP server or client to adjust one or more TCP parameters by delaying, duplicating or delaying ACKs, or by selectively dropping packets. In some embodiments, means 1008 causes a TCP server to increase a retransmission time out parameter value. The TCP server may be caused to increase the retransmission time out parameter value by changing a modem behavior related to transmission of acknowledgements from the modem. Means 1008 may cause a delay in transmission of one or more ACKs, vary a response time measured between receipt of packets at the modem and transmission of corresponding ACKs by the modem to obtain a desired variability of response times and/or withhold, or refrain from transmitting, one or more ACKs from the modem.

In one configuration, the apparatus 1002/1002′ for wireless communication includes means 1010 for manipulating certain aspects of TCP packet handling. Means 1010 may cause an increase in the RTO parameter value by changing a modem behavior related to transmission of one or more packets by the modem. Means 1010 may record a sequence of acknowledgments received by the modem and provide at least one of the recorded acknowledgements to the TCP server during the TA gap 724.

Means 1010 may cooperate to cause a TCP server to modify a transmit congestion window value. The transmit congestion window may be decreased prior to the event. Means 1010 may cause the TCP server to change a modem behavior related to transmission of acknowledgements from the modem. Means 1010 may cause transmission of at least one duplicate acknowledgement in response to a packet received by the modem. The duplicate acknowledgement may be a copy of an acknowledgement sent in response to a previous packet received by the modem.

In one configuration, the apparatus 1002/1002′ for wireless communication includes means 1012 adapting, manipulating or reconfiguring a TCP stack, server or client. Means 1012 may manipulate the TCP stack to cause delaying, duplicating or dropping ACKs, or by selectively dropping packets. Means 1012 may cause a TCP server to modify the one or more TCP parameters before during or after a TA gap 724. Manipulation of the TCP parameters may be caused after the occurrence of the TA event or during recovery period 806. The one or more TCP parameters may comprise one or more of a retransmission time out parameter, a transmit window parameter, and a parameter controlling delay of transmission of a packet acknowledge. Manipulating a TCP parameter after the occurrence of the event may include causing a TCP server to restore the values of the one or more TCP parameters to pre-event values. The one or more restored TCP parameters may comprise a retransmission time out parameter, and the server may restore the values of the includes causing the server to decrease the retransmission time out parameter value by half.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
determining a probability of occurrence of an event expected to occur within a period of time, the event comprising one or more of a tune-away event and a suspension event; and
manipulating one or more transmission control protocol (TCP) parameters before the event occurs when the probability of occurrence exceeds a threshold, wherein the manipulating is initiated by a wireless terminal.

2. The method of claim 1, wherein manipulating the one or more TCP parameters includes causing a TCP server to increase a retransmission time out parameter value.

3. The method of claim 2, wherein causing the TCP server to increase the retransmission time out parameter value includes changing a behavior of a modem, the behavior being related to transmission of acknowledgements from the modem.

4. The method of claim 3, wherein changing the behavior of the modem comprises delaying transmission of one or more of the acknowledgements or refraining from transmitting one or more acknowledgements from the modem.

5. The method of claim 3, wherein changing the behavior of the modem comprises varying a response time measured between receipt of packets at the modem and transmission of corresponding acknowledgements by the modem to obtain a desired variability of response times.

6. The method of claim 2, wherein causing the TCP server to increase the retransmission time out parameter value includes changing a behavior of a modem, the behavior being related to transmission of one or more packets by the modem.

7. The method of claim 6, wherein changing the behavior of the modem comprises recording a sequence of acknowledgments received by the modem and providing at least one of the sequence of acknowledgements to the TCP server during the event.

8. The method of claim 6, wherein the TCP server is maintained on the wireless terminal and wherein manipulating the one or more TCP parameters includes reconfiguring an operational feature of the TCP server.

9. The method of claim 1, wherein manipulating the one or more TCP parameters before the event occurs includes causing a TCP server to modify the one or more TCP parameters, and further comprising restoring at least one of the one or more TCP parameters after the event occurs to a pre-event value.

10. The method of claim 9, wherein the one or more TCP parameters comprise one or more of a retransmission time out parameter, a transmit window parameter, and a parameter controlling delay of transmission of a packet acknowledge.

11. The method of claim 9, wherein the one or more TCP parameters comprise a retransmission time out parameter, and wherein causing a server to restore the values includes causing the server to decrease a value of the retransmission time out parameter by half.

12. The method of claim 1, wherein manipulating the one or more TCP parameters includes causing a TCP server to modify a transmit congestion window value.

13. The method of claim 12, wherein the transmit congestion window is decreased prior to the event.

14. The method of claim 12, wherein manipulating the one or more TCP parameters includes causing the TCP server to increase a retransmission time out parameter value by changing a behavior of a modem, the behavior being related to transmission of acknowledgements from the modem.

15. The method of claim 14, wherein changing the behavior of the modem comprises transmitting at least one duplicate acknowledgement in response to a packet received by the modem.

16. The method of claim 15, wherein the at least one duplicate acknowledgement is a copy of an acknowledgement sent in response to a previous packet received by the modem.

17. The method of claim 1, wherein determining the probability of occurrence of the event includes determining a frequency of occurrence of a sequence of prior tune-away events.

18. The method of claim 17, wherein the frequency of occurrence of the sequence of prior tune-away events is determined based on a frequency of occurrence of TCP time outs.

19. The method of claim 17, further comprising reducing the frequency of occurrence of a plurality of further tune-away events based on the frequency of occurrence of the sequence of prior tune-away events.

20. The method of claim 1, wherein determining the probability of occurrence of the event includes determining an expected duration of the event, wherein the one or more TCP parameters are manipulated based on the expected duration.

21. A wireless terminal, comprising:
means for determining a probability of occurrence of an event expected to occur within a period of time, the event comprising one or more of a tune-away event and a suspension event; and
means for causing one or more transmission control protocol (TCP) parameters to be manipulated before the event occurs when the probability of occurrence exceeds a threshold.

22. The wireless terminal of claim 21, wherein the means for causing the one or more TCP parameters to be manipulated causes a TCP server to increase a retransmission time out parameter value.

23. The wireless terminal of claim 22, wherein the means for causing the TCP server to increase the retransmission time out parameter value changes a behavior of a modem, the behavior being related to transmission of acknowledgements from the modem.

24. The wireless terminal of claim 23, wherein the behavior of the modem is changed by delaying or inhibiting transmission of one or more of the acknowledgements from the modem.

25. The wireless terminal of claim 23, wherein the behavior of the modem is changed by varying a response time measured between receipt of packets at the modem and transmission of corresponding acknowledgements by the modem, wherein varying the response time causes the TCP server to modify a desired retransmission time out value.

26. The wireless terminal of claim 22, wherein the means for causing the one or more TCP parameters to be manipulated changes a behavior of a modem, the behavior being related to transmission of one or more packets by the modem.

27. The wireless terminal of claim 26, wherein the behavior of the modem is changed by retransmitting at least one of a previously recorded sequence of acknowledgments to the TCP server during the event.

28. The wireless terminal of claim 26, further comprising a TCP server, wherein the means for causing the one or more TCP parameters to be manipulated reconfigures one or more operational features of the TCP server.

29. The wireless terminal of claim 21, wherein the means for causing the one or more TCP parameters to be manipulated causes a TCP server to:
modify the one or more TCP parameters before the event occurs; and
after the event occurs, restore at least one of the one or more TCP parameters to a pre-event value.

30. The wireless terminal of claim 29, wherein the one or more TCP parameters comprise one or more of a retransmission time out parameter, a transmit window parameter, and a parameter controlling delay of transmission of a packet acknowledge.

31. The wireless terminal of claim 29, wherein the one or more TCP parameters comprise a retransmission time out parameter, and wherein the retransmission time out parameter has a value that is decreased by half after the event occurs.

32. The wireless terminal of claim 21, wherein the means for causing the one or more TCP parameters to be manipulated causes a TCP server to modify a transmit congestion window value.

33. The wireless terminal of claim 32, wherein the transmit congestion window is decreased prior to the event.

34. The wireless terminal of claim 32, wherein the means for causing the one or more TCP parameters to be manipulated causes the TCP server to increase a retransmission time out parameter value by changing a behavior of a modem, the behavior being related to transmission of acknowledgements from the modem.

35. The wireless terminal of claim 34, wherein the behavior of the modem is changed by transmitting at least one duplicate acknowledgement in response to a packet received by the modem.

36. The wireless terminal of claim 35, wherein the at least one duplicate acknowledgement is a copy of an acknowledgement sent in response to a previous packet received by the modem.

37. The wireless terminal of claim 21, wherein the means for determining the probability of occurrence of the event is based on a frequency of occurrence of a sequence of prior tune-away events.

38. The wireless terminal of claim 37, wherein the frequency of occurrence of the sequence of prior tune-away events is determined based on a frequency of occurrence of TCP time outs.

39. The wireless terminal of claim 37, further comprising means for reducing the frequency of occurrence of a plurality of tune-away events based on the frequency of occurrence of the sequence of prior tune-away events.

40. The wireless terminal of claim 21, wherein the means for determining the probability of occurrence of the event determines an expected duration of the event, wherein the one or more TCP parameters are manipulated based on the expected duration.

41. A wireless terminal, comprising:
a processing system configured to:
determine a probability of occurrence of an event expected to occur within a period of time, the event comprising one or more of a tune-away event and a suspension event; and
manipulate one or more transmission control protocol (TCP) parameters before the event occurs when the probability of occurrence exceeds a threshold.

42. The wireless terminal of claim 41, processing system is configured to manipulate the one or more TCP parameters by causing a TCP server to increase a retransmission time out parameter value.

43. The wireless terminal of claim 42, wherein causing the TCP server to increase the retransmission time out parameter value includes changing a behavior of a modem, the behavior being related to transmission of acknowledgements from the modem.

44. The wireless terminal of claim 43, wherein changing the behavior of the modem comprises delaying transmission of one or more of the acknowledgements or refraining from transmitting one or more acknowledgements from the modem.

45. The wireless terminal of claim 43, wherein changing the behavior of the modem comprises varying a response time measured between receipt of packets at the modem and transmission of corresponding acknowledgements by the modem to obtain a desired variability of response times.

46. The wireless terminal of claim 42, wherein causing the TCP server to increase the retransmission time out parameter value includes changing a behavior of a modem, the behavior being related to transmission of one or more packets by the modem.

47. The wireless terminal of claim 46, wherein changing the behavior of the modem comprises recording a sequence of acknowledgments received by the modem and providing at least one of the sequence of acknowledgements to the TCP server during the event.

48. The wireless terminal of claim 46, wherein the TCP server is maintained on the wireless terminal and wherein the processing system is configured to reconfigure an operational feature of the TCP server to manipulate the one or more TCP parameters.

49. The wireless terminal of claim 41, wherein the processing system is configured to:
cause a TCP server to modify the one or more TCP parameters before the event occurs;
cause the TCP server to restore at least one of the one or more TCP parameters after the event occurs to a pre-event value.

50. The wireless terminal of claim 49, wherein the one or more TCP parameters comprise one or more of a retransmission time out parameter, a transmit window parameter, and a parameter controlling delay of transmission of a packet acknowledge.

51. The wireless terminal of claim 49, wherein the one or more TCP parameters comprise a retransmission time out parameter, and wherein the processing system is configured to restore the at least one of the one or more TCP parameters by decreasing a value of the retransmission time out parameter by half.

52. The wireless terminal of claim 41, wherein manipulating the one or more TCP parameters includes causing a TCP server to modify a transmit congestion window value.

53. The wireless terminal of claim 52, wherein the transmit congestion window is decreased prior to the event.

54. The wireless terminal of claim 52, wherein the processing system is configured to manipulate the one or more TCP parameters by causing the TCP server to increase a retransmission time out parameter value by changing a behavior of a modem, the behavior being related to transmission of acknowledgements from the modem.

55. The wireless terminal of claim 54, wherein changing the behavior of the modem comprises transmitting at least one duplicate acknowledgement in response to a packet received by the modem.

56. The wireless terminal of claim 55, wherein the at least one duplicate acknowledgement is a copy of an acknowledgement sent in response to a previous packet received by the modem.

57. The wireless terminal of claim 41, wherein the processing system is configured to determine the probability of occurrence of the event by determining a frequency of occurrence of a sequence of prior tune-away events.

58. The wireless terminal of claim 57, wherein the frequency of occurrence of the sequence of prior tune-away events is determined based on a frequency of occurrence of TCP time outs.

59. The wireless terminal of claim 57, wherein the processing system is configured to reduce the frequency of occurrence of a plurality of tune-away events based on the frequency of occurrence of the sequence of prior tune-away events.

60. The wireless terminal of claim 41, wherein the processing system is configured to determine the probability of occurrence of the event by determining an expected duration of the event, wherein the one or more TCP parameters are manipulated based on the expected duration.

61. A computer program product, comprising:
a computer-readable medium comprising code for:
determining a probability of occurrence of an event expected to occur within a period of time, the event comprising one or more of a tune-away event and a suspension event; and
manipulating one or more transmission control protocol (TCP) parameters before the event occurs when the probability of occurrence exceeds a threshold.

62. The computer program product of claim 61, wherein manipulating the one or more TCP parameters includes causing a TCP server to increase a retransmission time out parameter value.

63. The computer program product of claim 62, wherein causing the TCP server to increase the retransmission time out parameter value includes changing a behavior of a modem, the behavior being related to transmission of acknowledgements from the modem.

64. The computer program product of claim 63, wherein changing the behavior of the modem comprises delaying transmission of one or more of the acknowledgements or refraining from transmitting one or more acknowledgements from the modem.

65. The computer program product of claim 63, wherein changing the behavior of the modem comprises varying a response time measured between receipt of packets at the modem and transmission of corresponding acknowledgements by the modem to obtain a desired variability of response times.

66. The computer program product of claim 62, wherein causing the TCP server to increase the retransmission time out parameter value includes changing a behavior of a modem, the behavior being related to transmission of one or more packets by the modem.

67. The computer program product of claim 66, wherein changing the behavior of the modem comprises recording a sequence of acknowledgments received by the modem and providing at least one of the sequence of acknowledgements to the TCP server during the event.

68. The computer program product of claim 66, wherein manipulating the one or more TCP parameters includes reconfiguring an operational feature of the TCP server.

69. The computer program product of claim 61, wherein manipulating the one or more TCP parameters before the event occurs includes causing a TCP server to modify the one or more TCP parameters, and further comprising restoring at least one of the one or more TCP parameters after the event occurs to a pre-event value.

70. The computer program product of claim 69, wherein the one or more TCP parameters comprise one or more of a retransmission time out parameter, a transmit window parameter, and a parameter controlling delay of transmission of a packet acknowledge.
